(19) United States
(12) Patent Application Publication
(10) Pub. No.: US 2025/0018507 A1
(43) Pub. Date: Jan. 16, 2025

(54) Terminal Strip Cutting and Welding System and Method

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Bellevue, WA (US); Lei (Alex) Zhou, Shanghai (CN); Leandro Santos, Greensboro, NC (US)

(73) Assignees: TE Connectivity Solutions GmbH, Schaffhausen (CH); Tyco Electronics (Shanghai) Co., Ltd., Shanghai (CN)

(21) Appl. No.: 18/770,857

(22) Filed: Jul. 12, 2024

(30) Foreign Application Priority Data
Jul. 12, 2023 (CN) 202310855766.7

(51) Int. Cl. B23K 31/02; B23K 37/04

(52) U.S. Cl. CPC B23K 31/02; B23K 37/04

(57) ABSTRACT

A terminal strip cutting and welding system includes a conveying module transporting a terminal strip to a cutting station and a welding station, a cutting module located at the cutting station and cutting a front end of a carrier strip of the terminal strip, and a welding module located at the welding station and welding the front end of the carrier strip of one terminal strip with a rear end of a carrier strip of another terminal strip. The welding connects the one terminal strip and another terminal strip into a continuous terminal strip. A distance between a pair of adjacent terminals on the continuous terminal strip is equal to a predetermined pitch.

### CROSS-REFERENCE TO RELATED APPLICATION

This application claims the benefit of the filing date under 35 U.S.C. § 119(a)-(d) of Chinese Patent Application No. 202310855766.7, filed on Jul. 12, 2023.

### FIELD OF THE INVENTION

The present invention relates to a terminal strip cutting and welding system and a terminal strip cutting and welding method.

### BACKGROUND OF THE INVENTION

In the prior art, in order to achieve continuous transportation of terminal strips, it is necessary to cut and weld two separated terminal strips to form a continuous terminal strip. However, in the prior art, two separated terminal strips are usually cut and welded manually, which reduces production efficiency.

### SUMMARY OF THE INVENTION

A terminal strip cutting and welding system includes a conveying module transporting a terminal strip to a cutting station and a welding station, a cutting module located at the cutting station and cutting a front end of a carrier strip of the terminal strip, and a welding module located at the welding station and welding the front end of the carrier strip of one terminal strip with a rear end of a carrier strip of another terminal strip. The welding connects the one terminal strip and another terminal strip into a continuous terminal strip. A distance between a pair of adjacent terminals on the continuous terminal strip is equal to a predetermined pitch.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a terminal strip according to an exemplary embodiment of the present invention;

FIG. 2 shows an illustrative view of two separated terminal strips, wherein the front end of one terminal strip is cut;

FIG. 3 shows an illustrative view of two separated terminal strips, wherein the front end of one terminal strip has been cut;

FIG. 4 shows an illustrative view of welding the cut front end of one terminal strip with a rear end of the other terminal strip;

FIG. 5 shows an illustrative view of cutting off an unqualified terminal from the terminal strip;

FIG. 6 shows an illustrative view of two separate terminal strips formed after cutting off the unqualified terminal;

FIG. 7 shows an illustrative view of welding the front and rear ends of the two separated terminal strips shown in FIG. 6 together;

FIG. 8 shows an illustrative perspective view of a terminal strip cutting and welding system according to an exemplary embodiment of the present invention;

FIG. 9 shows an illustrative perspective view of the conveying module of a terminal strip cutting and welding system according to an exemplary embodiment of the present invention;

FIG. 10 shows an illustrative perspective view of the cutting module of a terminal strip cutting and welding system according to an exemplary embodiment of the present invention;

FIG. 11 shows an illustrative perspective view of the first pin wheel and cutting module of a terminal strip cutting and welding system according to an exemplary embodiment of the present invention; and

FIG. 12 shows an illustrative perspective view of the welding module of a terminal strip cutting and welding system according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As shown in FIGS. 8-12, in an exemplary embodiment of the present invention, a terminal strip cutting and welding system is disclosed. The terminal strip cutting and welding system includes a conveying module 2, a cutting module 3, and a welding module 4. The conveying module 2 is used to sequentially transport a terminal strip 1 to the cutting station and the welding station.

The cutting module 3 is located at the cutting station to cut a front end 11a of a carrier strip 11 of one terminal strip 1, shown in FIGS. 1-6, to ensure that a distance between any two adjacent terminals 12 on a continuous terminal strip that is formed by welding the front end 11a of the carrier strip 11 of one terminal strip 1 with a rear end 11b of a carrier strip 11 of another terminal strip 1 is equal to a predetermined pitch P. The welding module 4 is located at the welding station to weld the front end 11a of the carrier strip 11 of the one terminal strip 1 with the rear end 11b of the carrier strip 11 of the other terminal strip 1, so that the two separated terminal strips 1 are connected into a continuous terminal strip 1.

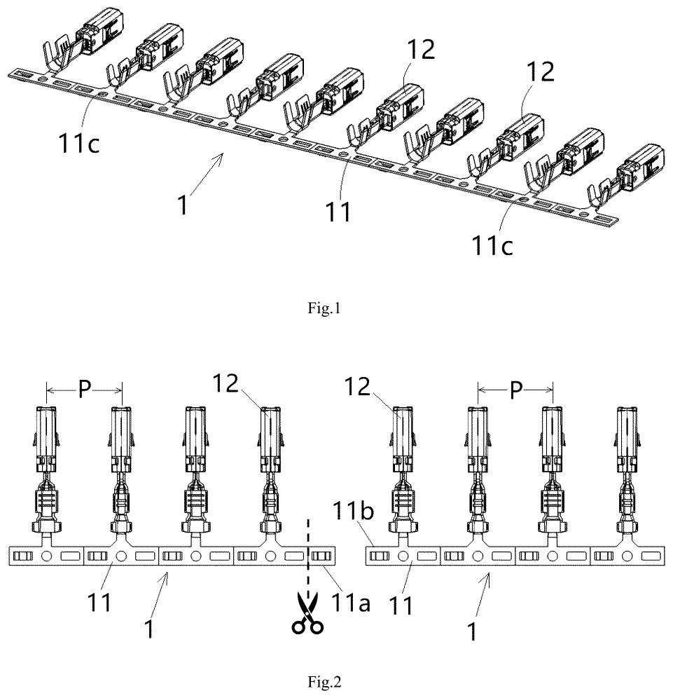

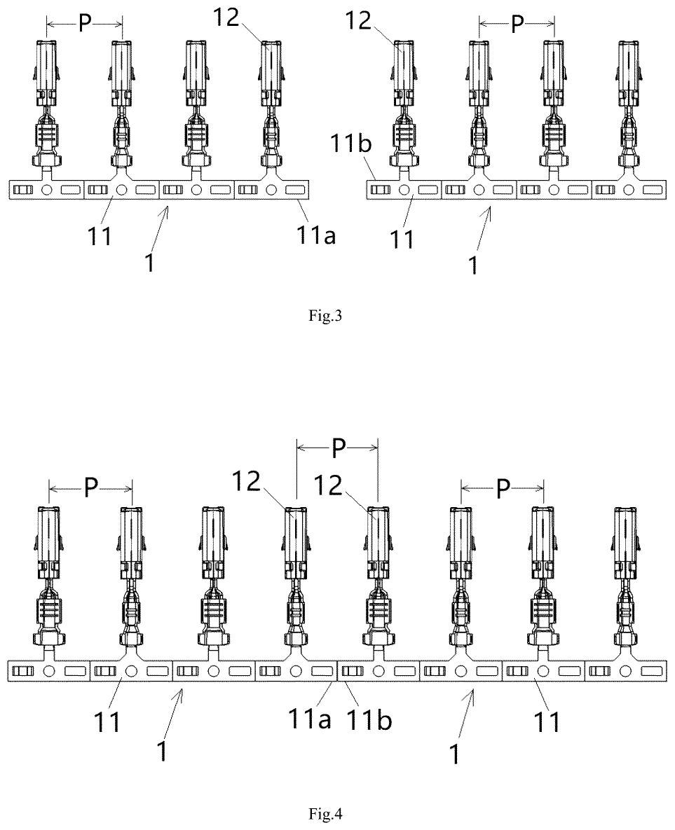

As shown in FIGS. 2 and 3, in the illustrated embodiment, the front end 11a of the carrier strip 11 of one terminal strip 1 has a flat welding end face after being cut by the cutting module 3. The welding end face of the front end 11a of the carrier strip 11 of one terminal strip 1 is welded to the rear end face of the rear end 11b of the carrier strip 11 of the other terminal strip 1.

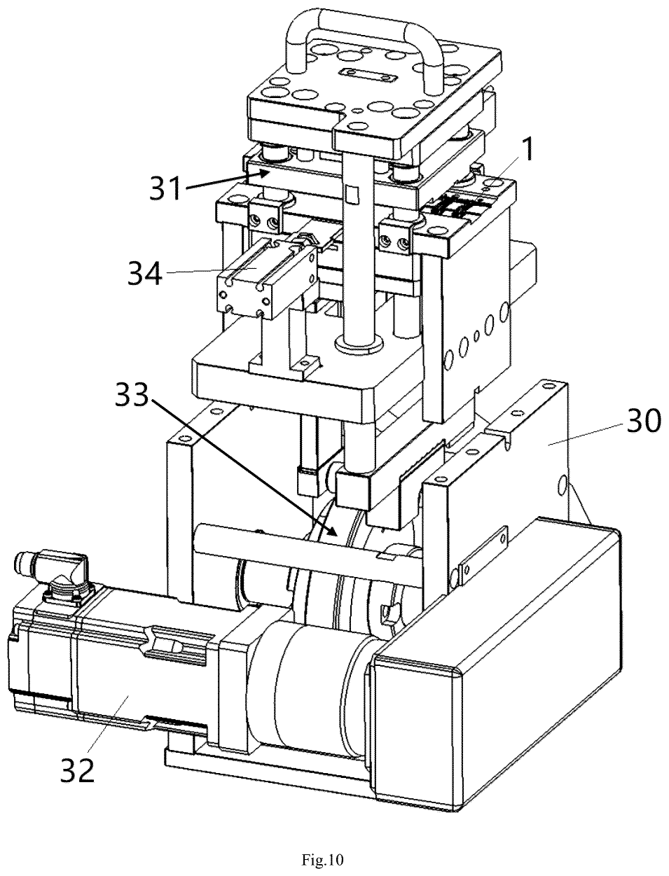

As shown in FIGS. 8 and 9, in the illustrated embodiment, the conveying module 2 includes a conveying channel 20, a first pin wheel 21, and a first driver 23. The conveying channel 20 is used to guide the terminal strip 1 to be sequentially transported along the predetermined conveying direction to the cutting station and the welding station. The first pin wheel 21 is located upstream of the cutting module 3 and is used to engage with the positioning hole 11c on the carrier strip 11 of the terminal strip 1, shown in FIG. 1. The first driver 23 is used to drive the first pin wheel 21 to rotate, in order to drive the terminal strip 1 to move along the conveying channel 20 through the first pin wheel 21.

As shown in FIGS. 9 and 11, in the illustrated embodiments, the first pin wheel 21 has multiple first pins 21c, which are evenly spaced in the circumferential direction of the first pin wheel 21 and are used to engage with the positioning holes 11c on the carrier strip 11 of the terminal strip 1, so that the terminal strip I can be driven to move along the conveying channel 20 by rotating the first pin wheel 21.

As shown in FIGS. 8 and 9, in the illustrated embodiment, the conveying module 2 further includes a second pin wheel 22 and a second driver 24. The second pin wheel 22 is located downstream of the welding module 4 and is used to engage with the positioning hole 11c on the carrier strip 11 of the terminal strip 1. The second driver 24 is used to drive the second pin wheel 22 to rotate, in order to drive the terminal strip 1 to move along the conveying channel 20 through the second pin wheel 22. In the illustrated embodiment, the first driver 23 and the second driver 24 can be servo motors.

As shown in FIG. 9, in the illustrated embodiments, the second pin wheel 22 has multiple second pins 22c, which are evenly spaced in the circumferential direction of the second pin wheel 22 and are used to engage with the positioning holes 11c on the carrier strip 11 of the terminal strip 1, so that the terminal strip I can be driven to move along the conveying channel 20 by rotating the second pin wheel 22.

As shown in FIGS. 8 and 9, in the illustrated embodiments, during the cutting and welding process of terminal strip 1, the first pin wheel 21 is engaged with the one terminal strip 1, and the second pin wheel 22 is engaged with the other terminal strip 1 to move the one terminal strip 1 and the other terminal strip 1 respectively through the first pin wheel 21 and the second pin wheel 22.

After the carrier strip 11 of the two terminal strips 1 is welded together, the first pin wheel 21 applies a predetermined tension on the carrier strip 11 of the one terminal strip 1, and the second pin wheel 22 applies a predetermined reverse tension on the carrier strip 11 of the other terminal strip 1, so as to detect whether the welding strength between the two terminal strips 1 reaches a predetermined value. If the welding part of the carrier strips 11 of the two terminal strips 1 is broken under the predetermined tension and the predetermined reverse tension, it is necessary to re-cut and weld the carrier strips 11 of the two terminal strips 1.

As shown in FIG. 9, in the illustrated embodiments, the conveying module 2 further comprises a first bracket 25 and a second bracket 26. The first pin wheel 21 is rotatably installed on the first bracket 25, and the first driver 23 is fixed on the first bracket 25 and connected to the first pin wheel 21. The second pin wheel 22 is rotatably installed on the second bracket 26, and the second driver 24 is fixed on the second bracket 26 and connected to the second pin wheel 22.

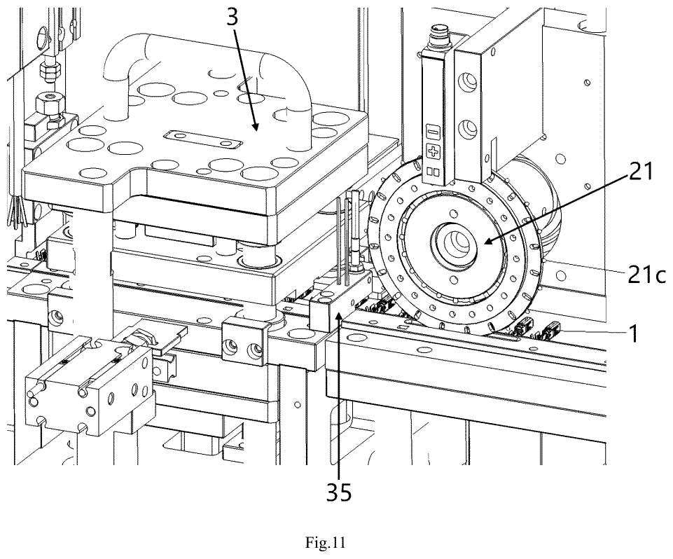

As shown in FIG. 10, in the illustrated embodiments, the cutting module 3 comprises a cutting die 31 and a driving mechanism 32, 33. The cutting die 31 can be opened and closed for cutting the carrier strip 11 of the terminal strip 1. The driving mechanism 32, 33 is used to drive the cutting die 31 to cut the carrier strip 11 of the terminal strip 1. In the illustrated embodiments, the driving mechanism 32, 33 includes a cam 33 and a motor 32. The cam 33 is connected to the cutting die 31. The output shaft of motor 32 is connected to the cam 33, which is used to drive the cam 33 to rotate and drive the cutting die 31 to open and close through the cam 33.

As shown in FIG. 10, in the illustrated embodiments, the cutting module 3 further includes a first positioning device 34 for positioning the front end 11a of the carrier strip 11 of one terminal strip 1 at a predetermined cutting position to prevent movement of the carrier strip 11 of the one terminal strip 1 when it is cut. The first positioning device 34 includes a first positioning pin and a first driving device. The first positioning pin can be moved between a locking position that is engaged with the positioning hole 11c on the front end of the carrier strip 11 of one terminal strip 1 and an unlocking position that is separated from the positioning hole 11c. The first driving device is used to drive the first positioning pin to move between the locked position and the unlocked position.

As shown in FIG. 11, in the illustrated embodiment, the cutting module 3 further includes a first position sensor 35, which is used to detect whether the front end 11a of the carrier strip 11 of one terminal strip 1 has been transported to the predetermined shearing position.

As shown in FIG. 10, in the illustrated embodiments, the cutting module 3 further includes an installation bracket 30. The cutting die 31, the driving mechanism 32, 33, the first positioning device 34, and the first position sensor 35 are installed on the mounting bracket 30.

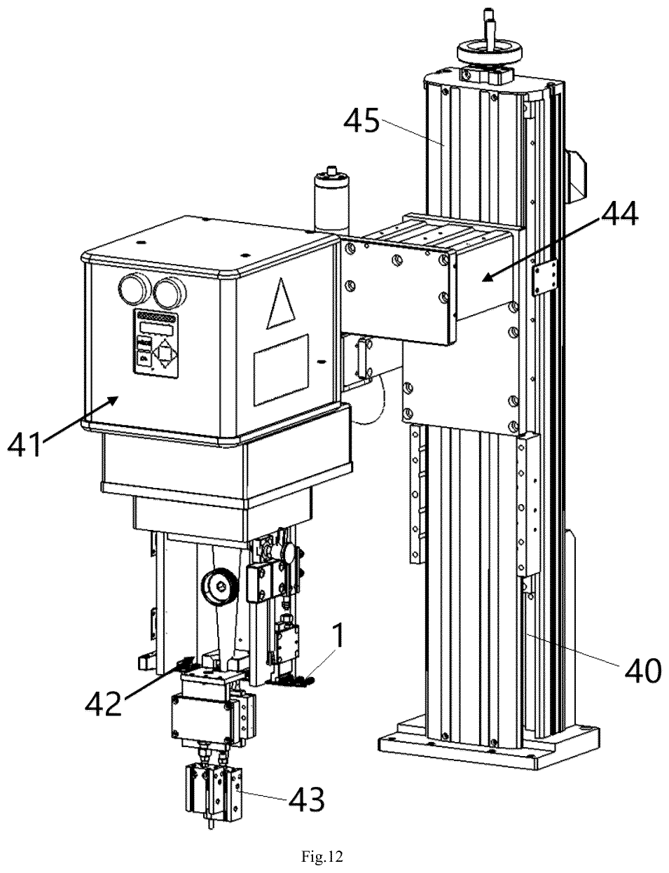

As shown in FIG. 12, in the illustrated embodiments, the welding module 4 includes a laser welder 41, which is used to weld the front end 1a of the carrier strip 11 of one terminal strip 1 and the rear end 1b of the carrier strip 11 of the other terminal strip 1 together. In the illustrated embodiments, the welding module 4 further includes a second positioning device 42, which is used to position the front end 11a of the carrier strip 11 of one terminal strip 1 and the rear end 1b of the carrier strip 11 of the other terminal strip 1 at a predetermined welding position to prevent movement of the carrier strips 11 of one terminal strip 1 and the other terminal strip 1 during welding.

As shown in FIG. 12, in the illustrated embodiment, the second positioning device 42 includes multiple second positioning pins and a second driving device 43. Multiple second positioning pins can be moved between the locking position engaged with the positioning holes 11c on the carrier strips 11 of one terminal strip 1 and the other terminal strip 1, and the unlocking position separated from the positioning holes 11c. The second driving device 43 is used to drive multiple second positioning pins to move between the locking position and the unlocking position.

In the illustrated embodiments, the welding module 4 includes a second position sensor, which is used to detect whether the front end 11a of the carrier strip 11 of one terminal strip 1 and the rear end 11b of the carrier strip 11 of the other terminal strip 1 have been transported to the predetermined welding position.

As shown in FIG. 12, in the illustrated embodiments, the welding module 4 further comprises a vertical bracket 40 and a vertical guide rail 45 fixed on vertical bracket 40. A slider 44 is slidably onto the vertical guide rail 45 to move along it. The laser welder 41 is connected to the slider 44 to be able to move along a vertical direction with the slider 44.

In another exemplary embodiment of the present invention, a terminal strip cutting and welding method is also disclosed. The cutting and welding method of the terminal strip includes the following steps of:

S11: providing the aforementioned terminal strip cutting and welding system;

S12: transporting a front end 11a of a carrier strip 11 of one terminal strip 1 to a predetermined cutting position;

S13: as shown in FIGS. 2 and 3, cutting the front end 11a of the carrier strip 11 of the one terminal strip 1;

S14: transporting the front end 11a of the carrier strip 11 of one terminal strip 1 to a predetermined welding position; and

S15: as shown in FIG. 4, welding the front end 11a of the carrier strip 11 of one terminal strip 1 with a rear end 11b of a carrier strip 11 of the other terminal strip 1.

In another exemplary embodiment of the present invention, a terminal strip cutting and welding method is also disclosed. The cutting and welding method of the terminal strip 1 includes the following steps of:

S21: providing the aforementioned terminal strip cutting and welding system;

S22: transporting the unqualified terminal 12 on a continuous terminal strip 1 to a predetermined cutting position;

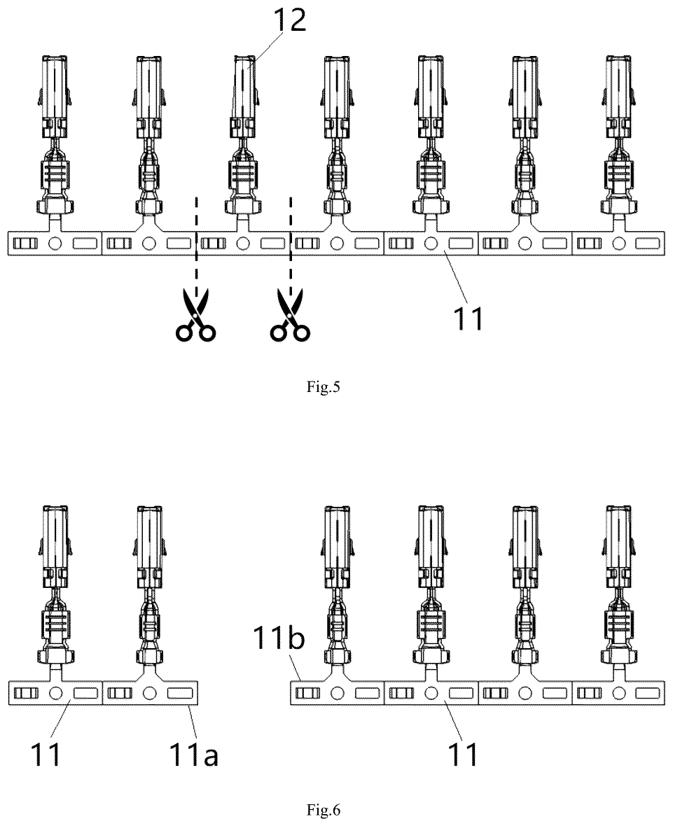

S23: As shown in FIGS. 5 and 6, removing the unqualified terminal 12 from the terminal strip 1 by cutting off the carrier strip 11 of the terminal strip 1;

S24: transporting the front end 11a of one of two separated terminal strips 1 formed by cutting off the carrier strip 11 and the rear end 11b of the other of the two separated terminal strips 1 to a predetermined welding position; and

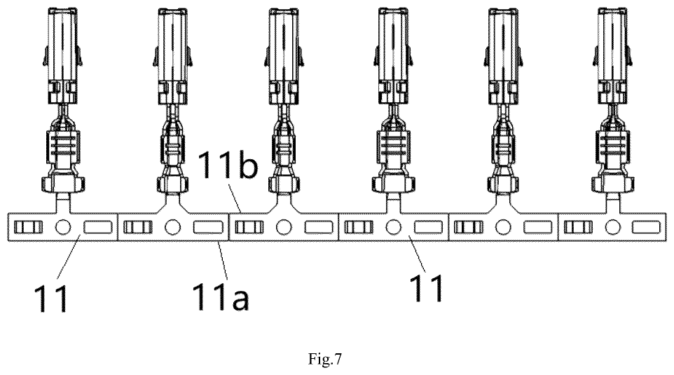

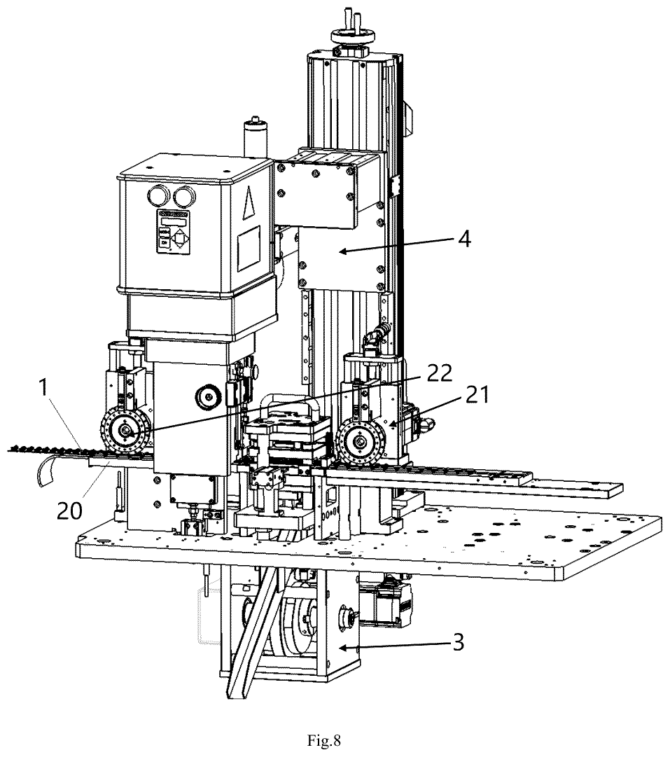

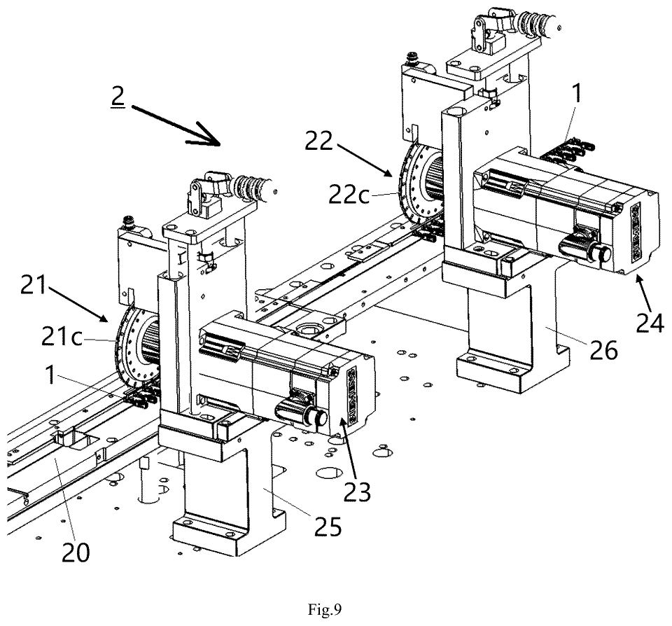

S25: As shown in FIG. 7, welding the front end 11a of one of two separated terminal strips 1 with the rear end 11b of the other of the two separated terminal strips 1.

In the aforementioned exemplary embodiments of the present invention, the terminal strip cutting and welding system can automatically achieve the cutting and welding operations of the terminal strips, greatly improving production efficiency.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A terminal strip cutting and welding system, comprising:
a conveying module transporting a terminal strip to a cutting station and a welding station;
a cutting module located at the cutting station and cutting a front end of a carrier strip of the terminal strip; and
a welding module located at the welding station and welding the front end of the carrier strip of one terminal strip with a rear end of a carrier strip of another terminal strip to connect the one terminal strip and the another terminal strip into a continuous terminal strip, a distance between a pair of adjacent terminals on the continuous terminal strip is equal to a predetermined pitch.

2. The terminal strip cutting and welding system according to claim 1, wherein the front end of the carrier strip of the one terminal strip has a welding end face that is flat after being cut by the cutting module, the welding end face of the front end of the carrier strip of the one terminal strip is welded to a rear end face of the rear end of the carrier strip of the another terminal strip.

3. The terminal strip cutting and welding system according to claim 1, wherein the conveying module includes:
a conveying channel guiding the terminal strip along a predetermined conveying direction to the cutting station and the welding station;
a first pin wheel located upstream of the cutting module and engaging a positioning hole on the carrier strip of the one terminal strip; and
a first driver driving the first pin wheel to rotate, the first pin wheel has a plurality of first pins evenly spaced in a circumferential direction of the first pin wheel and engaging the positioning hole on the carrier strip of the one terminal strip, the first driver drives the one terminal strip to move along the conveying channel by rotating the first pin wheel.

4. The terminal strip cutting and welding system according to claim 3, wherein the conveying module includes:
a second pin wheel located downstream of the welding module and engaging the positioning hole on the carrier strip of the one terminal strip; and
a second driver driving the second pin wheel to rotate, the second pin wheel has a plurality of second pins evenly spaced in a circumferential direction of the second pin wheel and engaging the positioning hole on the carrier strip of the one terminal strip, the second driver drives the one terminal strip to move along the conveying channel by rotating the second pin wheel.

5. The terminal strip cutting and welding system according to claim 4, wherein, during cutting and welding of the terminal strip, the first pin wheel engages with the one terminal strip and the second pin wheel engages with the another terminal strip.

6. The terminal strip cutting and welding system according to claim 5, wherein after the carrier strip of the one terminal strip and the carrier strip of the another terminal strip are welded together, the first pin wheel applies a predetermined tension on the carrier strip of the one terminal strip and the second pin wheel applies a predetermined reverse tension on the carrier strip of the another terminal strip to detect whether a welding strength between the one terminal strip and the another terminal strip reaches a predetermined value, and if a welding part of the carrier strips is broken under the predetermined tension and the predetermined reverse tension, the carrier strips are re-cut and welded.

7. The terminal strip cutting and welding system according to claim 4, wherein the conveying module includes:
a first bracket, the first pin wheel is rotatably installed on the first bracket and the first driver is fixed on the first bracket and connected to the first pin wheel; and
a second bracket, the second pin wheel is rotatably installed on the second bracket and the second driver is fixed on the second bracket and connected to the second pin wheel.

8. The terminal strip cutting and welding system according to claim 1, wherein the cutting module includes a cutting die and a driving mechanism driving the cutting die to open and close to cut the carrier strip.

9. The terminal strip cutting and welding system according to claim 8, wherein the driving mechanism includes a cam connected to the cutting die and a motor connected to the cam to drive the cam to rotate, driving the cutting die to open and close through the cam.

10. The terminal strip cutting and welding system according to claim 8, wherein the cutting module includes a first positioning device positioning the front end of the carrier strip of the one terminal strip at a predetermined cutting position and preventing the carrier strip of the one terminal strip from being moved when it is cut.

11. The terminal strip cutting and welding system according to claim 10, wherein the first positioning device includes:
a first positioning pin movable between a locking position engaged with a positioning hole on the front end of the carrier strip of the one terminal strip and an unlocking position separated from the positioning hole; and
a first driving device driving the first positioning pin to move between the locking position and the unlocking position.

12. The terminal strip cutting and welding system according to claim 10, wherein the cutting module includes a first position sensor detecting whether the front end of the carrier strip of the one terminal strip has been transported to the predetermined cutting position.

13. The terminal strip cutting and welding system according to claim 12, wherein the cutting module includes an installation bracket, the cutting die, the driving mechanism, the first positioning device, and the first position sensor are installed on the installation bracket.

14. The terminal strip cutting and welding system according to claim 1, wherein the welding module includes a laser welder used to weld the front end of the carrier strip of the one terminal strip and the rear end of the carrier strip of the another terminal strip together.

15. The terminal strip cutting and welding system according to claim 14, wherein the welding module includes a second positioning device positioning the front end of the carrier strip of the one terminal strip and the rear end of the carrier strip of the another terminal strip at a predetermined welding position, preventing the carrier strips from being moved during welding.

16. The terminal strip cutting and welding system according to claim 15, wherein the second positioning device includes:
a plurality of second positioning pins movable between a locking position engaged with a plurality of positioning holes on the carrier strips of the one terminal strip and the another terminal strip and an unlocking position separated from the positioning holes; and
a second driving device driving the second positioning pins to move between the locking position and the unlocking position.

17. The terminal strip cutting and welding system according to claim 15, wherein the welding module includes a second position sensor detecting whether the front end of the carrier strip of the one terminal strip and the rear end of the carrier strip of the another terminal strip have been transported to the predetermined welding position.

18. The terminal strip cutting and welding system according to claim 14, wherein the welding module includes a vertical bracket, a vertical guide rail fixed on the vertical bracket, and a slider slidably installed on the vertical guide rail and movable along the vertical guide rail, the laser welder is connected to the slider and movable along a vertical direction with the slider.

19. A terminal strip cutting and welding method, comprising:
transporting a front end of a carrier strip of one terminal strip to a predetermined cutting position;
cutting the front end of the carrier strip of the one terminal strip;
transporting the front end of the carrier strip of the one terminal strip to a predetermined welding position; and
welding the front end of the carrier strip of the one terminal strip with a rear end of a carrier strip of another terminal strip.

20. A terminal strip cutting and welding method, comprising:
transporting an unqualified terminal on a terminal strip to a predetermined cutting position;
removing the unqualified terminal from the terminal strip by cutting off a carrier strip of the terminal strip;
transporting a front end of one of a pair of separated terminal strips formed by cutting off the carrier strip and a rear end of the other of the pair of separated terminal strips to a predetermined welding position; and
welding the front end of the one of the pair of separated terminal strips with the rear end of the other of the pair of separated terminal strips.
